(19) United States
(12) Patent Application Publication
(10) Pub. No.: US 2014/0157840 A1
(43) Pub. Date: Jun. 12, 2014

(54) Mechanical Apparatus and Methods for Restricting Access to a Gas Source

(71) Applicant: The Rectorseal Corporation, (US)

(72) Inventors: Robert Allen Martinelli, Katy, TX (US); Zheng-Yi Xu, Houston, TX (US); Michael A. Moore, Dighton, MA (US)

(73) Assignee: The Rectorseal Corporation, Houston, TX (US)

(21) Appl. No.: 13/785,102

(22) Filed: Mar. 5, 2013

Related U.S. Application Data
(60) Provisional application No. 61/797,424, filed on Dec. 6, 2012.

(51) Int. Cl. B65D 50/06; F16L 55/115

(52) U.S. Cl. CPC B65D 50/067; F16L 55/1157
USPC 70/163

(57) ABSTRACT

A cap lock system for limiting access to an access port of a gaseous system includes an outer cap including first and second key insertion passages, an inner lock having first and second key receivers and a rotatable key having first and second engagement fingers each engageable with an aligned set of key insertion passages and key receivers.

This application claims priority to U.S. Provisional Patent Application Ser. No. 61/797,424 filed on Dec. 6, 2012, which is hereby incorporated by reference herein in its entirety.

### FIELD OF THE INVENTION

The present disclosure relates generally to gas access technology, more particularly, to apparatus and methods for restricting easy access to a gas source.

### BACKGROUND OF THE INVENTION

Various systems include gasses that are useful or necessary, but may be harmful to humans if inhaled in particular concentrations. Consequently, it may be undesirable to allow easy access to gases utilized in many types of systems.

Over the years, there has been evidence of people intentionally inhaling potentially dangerous gases having an otherwise meaningful or necessary use. For example, children and young adults have been known to tap into refrigerant lines of air conditioning systems to inhale Freon in order to get “high”. Access is often easy, for example, in systems utilizing a “Schrader” valve, which is commonly included to be able to adjust refrigerant levels. In a typical Schrader valve system, refrigerant can be added or released by simply unscrewing a threaded cap to gain access to the center pin of the Schrader valve. The pin is then depressed to inject or expel the gas. These threaded caps are normally included to cover and protect the center pin from damage, but do not restrict unauthorized access to the valve and gas. To limit easy access to compressed refrigerant gasses in air conditioning systems, some local jurisdictions in the U.S. have enacted legislation, regulations or code requirements requiring an effective locking mechanism on the refrigerant access points.

Presently known technologies for preventing or limiting easy or unauthorized access to gas sources or other items may have one or more drawbacks. For example, protective cap devices have been developed for restricting access into containers, such as medicines or poisons. Some of these tamper resistant caps require only that the cap be depressed slightly while rotating the cap. Some examples of prior art patents in this area include U.S. Pat. Nos. 6,032,811, 3,426,932 and 738,917.

Prior art in the field of refrigerant caps includes a product called Novent. This product is designed to restrict unauthorized access to the refrigerant port of a Schrader valve. The Novent product is described in U.S. Pat. No. 6,612,455, which sets forth a cap having an outer cover that spins freely around an inner lock to prevent access to the Schrader valve. The outer cap has a keyhole leading into a recessed cavity of the inner lock. A key is inserted to allow access to the Schrader valve. When the key is turned, a tab pivotally abuts an annular flange causing the inner lock to be wedged against the outer cap. However, this locking mechanism may have disadvantages. For example, because this device requires friction, the cap assembly cannot usually be tightly (i.e. wrench tight) fitted onto the valve, thus allowing it to be removed. For another example, after the inner lock is inserted into the outer cap, the bottom of the outer cap must be pounded with a blunt instrument (e.g. hammer or mallet) to compress the bottom opening of the outer cap around the inner lock. This blunt force striking of the outer cap is not precise, adds an additional assembly step and may damage the overall apparatus.

For another example, because the keyhole is on top of the device, it is particularly easy using gravity alone to insert adhesives or abrasive materials into the keyhole to effectively connect the inner lock and outer cap, allowing easy access to the Schrader valve by simply turning the outer cap. For yet another example, the internal “wedge” design of this assembly is complex and must be almost perfectly aligned in order to function, requiring the cap assembly to be manufactured with tight tolerances, resulting in high manufacturing costs and significant failure and quality control concerns.

It should be understood that the above-described features, capabilities and disadvantages are provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features, capabilities or disadvantages merely because of the mention thereof herein.

Accordingly, there exists a need for improved systems, apparatus and methods useful to assist in restricting access to gas sources having one or more of the attributes or capabilities described or shown in, or as may be apparent from this patent.

### BRIEF SUMMARY OF THE DISCLOSURE

In some embodiments, the present disclosure involves a cap lock system for limiting access to an access port of a gaseous system. The cap lock system includes an outer cap, inner cap and a rotatable key. The outer cap has upper and lower ends, a cavity and an opening to the cavity formed in its lower end. The side wall of the outer cap has a lower rim forming the opening and extending around the cavity. The outer cap includes at least first and second key insertion passages formed in opposing sides of the lower rim and/or the side wall and extending into the cavity.

The inner lock of these embodiments has upper and lower ends, a cavity and an opening to the cavity formed in its lower end. The side wall of the inner lock has a lower rim forming its opening and extending around its cavity. The inner lock is configured to fit and independently rotate within the cavity of the outer cap and releasably engage the access port of the gaseous system. The inner lock also has at least first and second key receivers formed in opposing sides of the lower rim and/or the side wall thereof. The key receivers align with and under the respective key insertion passages of the outer cap when the inner lock in disposed within the cavity of the outer cap. When the inner lock is disposed within the outer cap, the inner lock is inaccessible other than through the aligned key insertion passages and key receivers.

The rotatable key of these embodiments has at least first and second engagement fingers configured to be engaged with the respective aligned key insertion passages of the outer cap and key receivers of the inner lock. When the inner lock is engaged with the gaseous system and disposed within the cavity of the outer cap, and the engagement arms engage the respective aligned key insertion passages and key receivers, the key is configured to be rotated to cause concurrent rotation of the outer cap and the inner lock relative to the gaseous system, disconnecting the inner lock from the access port of the gaseous system.

The present disclosure includes features and advantages which are believed to enable it to advance gas access technology. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1(a) is an exploded view of a cap lock assembly including an exemplary inner lock, outer cap and snap ring in accordance with an embodiment of the present disclosure;

FIG. 1(b) is side view of the assembled cap lock assembly of FIG. 1(a);

FIG. 1(c) is a cross sectional view of the cap lock assembly of FIG. 1(b) taken along line A-A;

FIG. 1(d) is a perspective view of the cap lock assembly of FIG. 1(b) engaged with an exemplary key;

FIG. 2(a) is a cross-sectional view of the cap lock assembly of FIG. 1(b) and an exemplary key prior to engagement therewith;

FIG. 2(b) is a cross-sectional view of the cap lock assembly of FIG. 1(b) shown engaged with the exemplary key of FIG. 2(a);

FIG. 3(a) is an exploded view of another embodiment of a cap lock assembly including an exemplary inner lock, outer cap and snap ring in accordance with the present disclosure;

FIG. 3(b) is side view of the assembled cap lock assembly of FIG. 3(a);

FIG. 3(c) is a cross-sectional view of the cap lock assembly of FIG. 3(b) taken along line A-A;

FIGS. 4(a) is a perspective view of the cap lock assembly of FIG. 3(b) engaged with an exemplary key;

FIGS. 4(b) is a top view of the exemplary cap lock assembly and engaged key shown in FIG. 4(a);

FIG. 4(c) is a side view of the exemplary cap lock assembly and engaged key shown in FIG. 4(a);

FIG. 4(d) is a cross-sectional view of the exemplary cap lock assembly and engaged key shown in FIG. 4(c) taken along lines A-A;

FIG. 4(e) is a top view of the exemplary key of FIG. 4(a);

FIG. 5(a) is an exploded view of another embodiment of a cap lock assembly including an exemplary inner lock, outer cap and snap ring in accordance with the present disclosure;

FIG. 5(b) is side view of the assembled cap lock assembly of FIG. 5(a);

FIG. 5(c) is a cross-sectional view of the cap lock assembly of FIG. 5(b) taken along line A-A;

FIG. 6(a) is a perspective view of the cap lock assembly of FIGS. 5(b) and an exemplary key having a tightener;

FIG. 6(b) is a perspective view of the cap lock assembly of FIG. 6(a) engaged with the illustrated key;

FIG. 6(c) is a cross-sectional view of the cap lock assembly and key of FIG. 6(b) shown with the exemplary tightener moved into an engaged position;

FIG. 7 is a perspective view of another embodiment of a cap lock assembly and exemplary key in accordance with the present disclosure; and

FIG. 8 is a cross-sectional view of another embodiment of a cap lock assembly in accordance with the present disclosure.

### DETAILED DESCRIPTION OF PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments in the appended figures, common or similar elements are referenced with like or identical reference numerals or are apparent from the figures and/or the description herein. The figures are not necessarily to scale and certain features and certain views of the figures may be shown exaggerated in scale or in schematic in the interest of clarity and conciseness.

As used herein and throughout various portions (and headings) of this patent application, the terms “invention”, “present invention” and variations thereof are not intended to mean every possible embodiment encompassed by this disclosure or any particular claim(s).

Thus, the subject matter of each such reference should not be considered as necessary for, or part of, every embodiment hereof or of any particular claim(s) merely because of such reference. The terms “coupled”, “connected”, “engaged” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

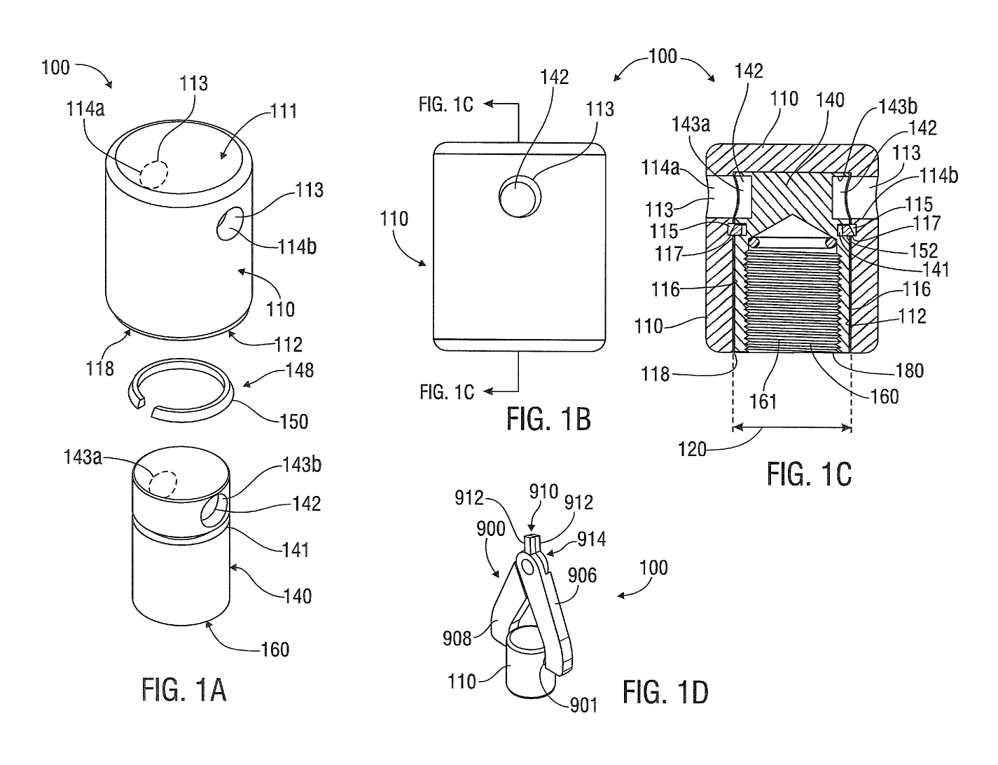

Referring initially to the embodiment of FIGS. 1(a)-(d), an example cap lock system 100 includes an outer cap 110, inner lock 140 and a key 900. The inner lock 140 is configured to fit within the outer cap 110 and engage a gas source (not shown) at its lower end. The outer cap 110 limits access to the inner lock 140 and gas source, while the key 900 (FIG. 1(d)) allows access to the gas source. The outer cap 110, inner lock 140 and key 800 may have any suitable form, configuration and operation, may be constructed of any suitable material or combination of materials, such as, for example, stainless steel, aluminum or molded plastic, and may be manufactured by any suitable process, such as machining, casting, stamping or molding.

In this embodiment, the outer cap 110 is generally cylindrically-shaped and includes a generally cylindrically-shaped main cavity 112 and an opening 118 into the cavity 112. However, any other suitable or desirable shapes may be used. The upper end 111 of the exemplary outer cap 110 (opposite the opening 118) is closed. The illustrated main cavity 112 and opening 118 are sized so that the inner lock 140 can slide into the outer cap 110 and fit snugly in the main cavity 112. When the exemplary inner lock 140 is disposed within the outer cap 110, rotation of the outer cap 110 is not translated to the inner lock 140. In a preferred embodiment, the outer cap 110 is configured so that the inner lock 140 may slide into the outer cap 110 and rotate therein without significant friction therebetween. For example, in the embodiment of FIG. 1(c), the cavity wall 116 of the outer cap 110 is shaped to fit snugly around the outside diameter of inner lock 140, but allowing sufficient space therebetween to avoid friction when one is moved relative to the other.

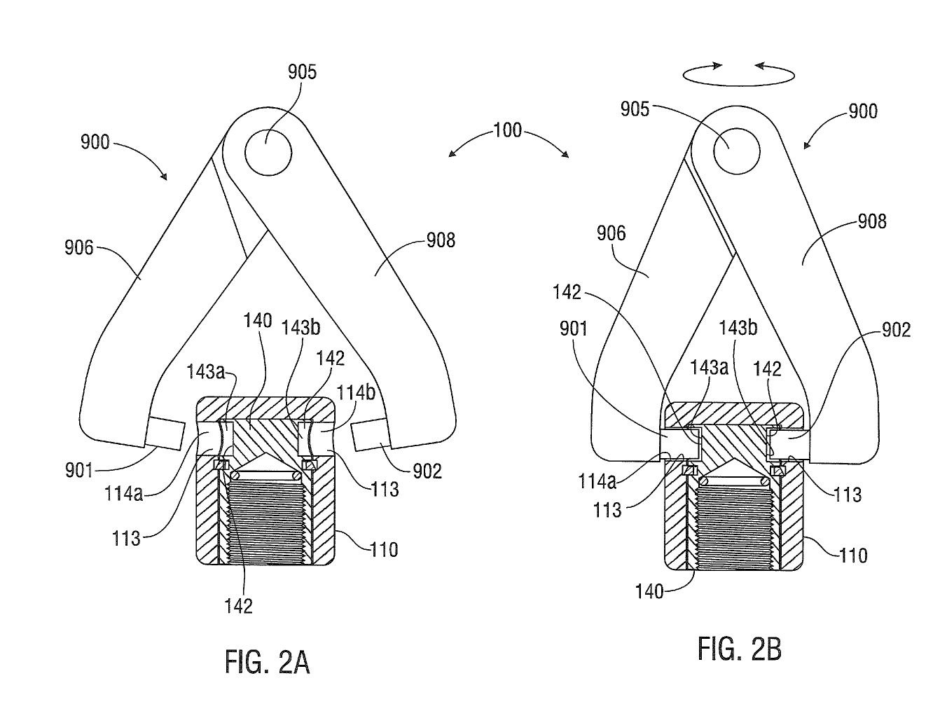

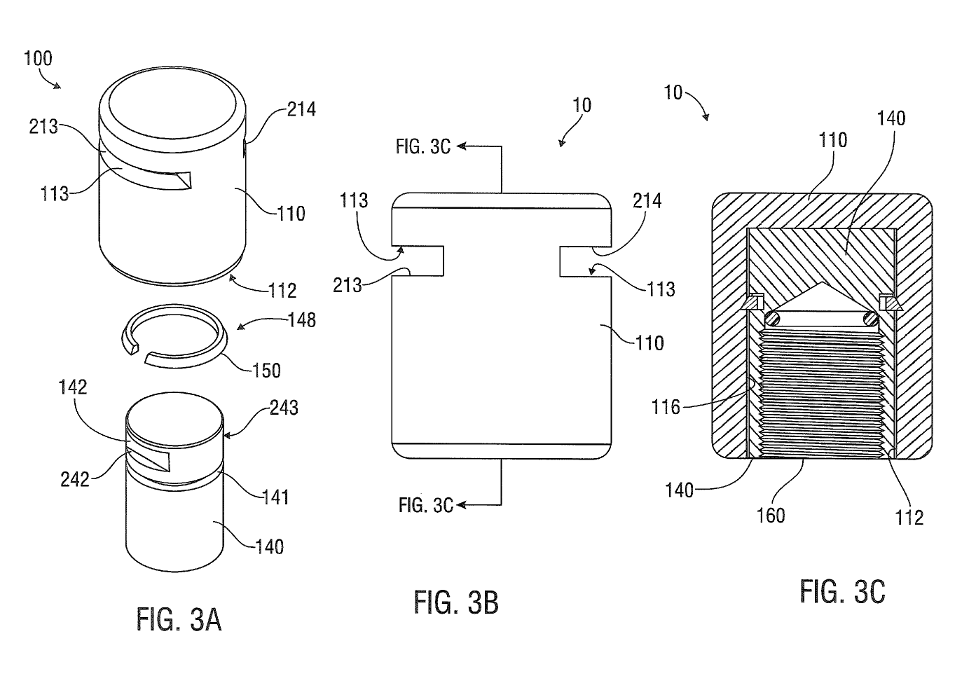

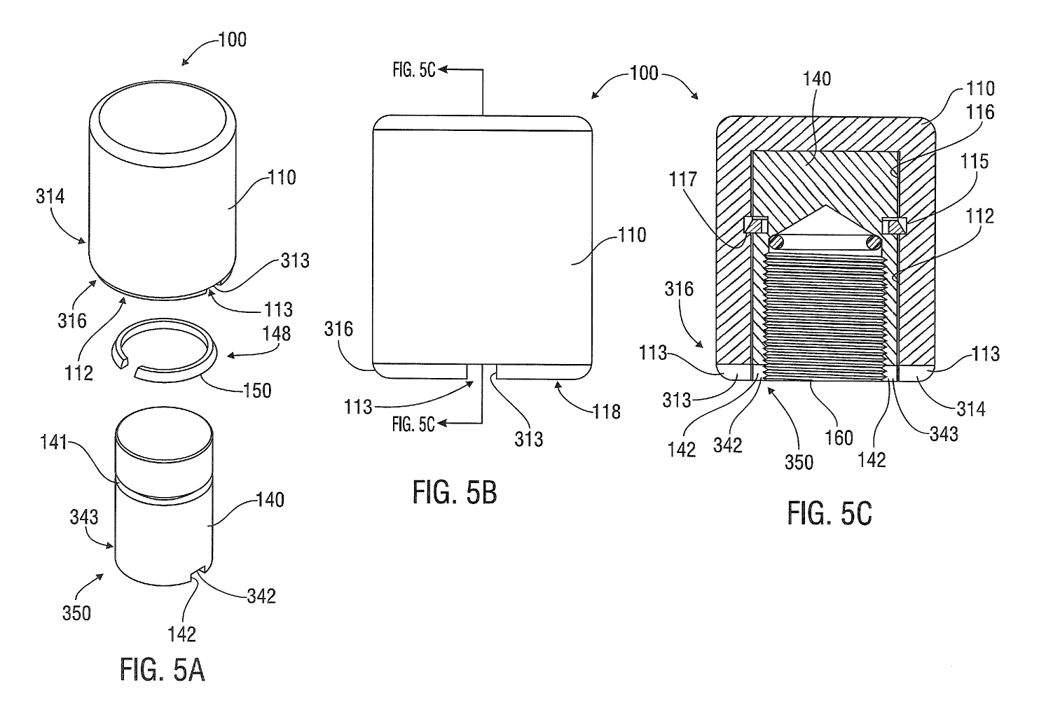

Still referring to the embodiment of FIGS. 1(a)-(d), the outer cap 110 also includes at least one key insertion passage 113 extending therethrough into the main cavity 112. As will be described below, the exemplary key insertion passage 113 allows passage therethrough of an engagement finger 901 (FIG. 1d) of the key 900. The key insertion passage 113 may have any suitable form, configuration and operation. In this example, the key insertion passage 113 includes at least two holes 114a, 114b formed into opposite sides of the outer cap 110. Each illustrated hole 114a, 114b is sized to allow insertion therethrough of an engagement finger 901 of the key 900 (see e.g. FIGS. 2(a) and (b)). For another example, in the embodiment of FIGS. 3(a)-(c), the key insertion passage 113 includes a pair of opposing channels 213, 214. For yet another example, the key insertion passage 113 of FIGS. 5(a)-(c) includes a pair of opposing notches 313, 314.

Referring back to FIGS. 1(a)-(d), the illustrated inner lock 140 is also generally cylindrically shaped, but may have any other suitable shape as may be desired. The exemplary inner lock 140 includes an inner lock cavity 160 and an opening 180 into the cavity 160 at the lower end thereof. At the cavity 160, the illustrated inner lock 140 is configured to engage the gas source (not shown). In this example, the cavity 160 includes threads 161 for threaded engagement with the gas source (not shown), such as the threaded portion of a Schrader valve or other component associated with a gaseous system or gas container. If desired, the cavity 160 may not be threaded. Moreover, the inner lock 140 may engage the gas source in any suitable manner and the present disclosure is not limited by the type, configuration or operation of the gas source or the method of engaging the inner lock 140 therewith.

Still referring to FIGS. 1(a)-(d), the exemplary inner lock 140 includes at least one key receiver 142 that aligns under the key insertion passage(s) 113 of the outer cap 110 when the inner lock 140 is engaged in the main cavity 112. The key receiver 142 may have any suitable form, configuration and operation. In this embodiment, the key receiver 142 includes at least two opposing indents 143a, 143b formed into opposite sides of the inner lock 140. Each illustrated indent 143a, 143b is sized to allow insertion therein of an engagement finger 901 of the key 900 (see e.g. FIGS. 2(b)). For another example, in the embodiment of FIGS. 3(a)-(c), the key receiver 142 includes a pair of opposing channels 242, 243. For yet another example, the key receiver 142 of FIGS. 5(a)-(c) includes a pair of opposing notches 342, 343.

Referring back to FIGS. 1(a)-(d), the illustrated inner lock 140 is configured so that when it is inserted into the main cavity 112 of the outer cap 110, the inner lock 140 is retained therein and not easily removable. In this embodiment, the main cavity 112 of the outer cap 110 completely encapsulates the sides of the inner lock 140 so that the inner lock 140 cannot be directly gripped or rotated. The only parts of the inner lock 140 that are accessible are the key receiver(s) 142. This prevents unauthorized access to or manipulation of the inner lock 140 and the gas source (not shown) engaged therewith, such as by a potential abuser of refrigerant gas.

The exemplary inner lock 140 may be retained within the main cavity 112 in any suitable manner. For example, the cap lock system 100 may include one or more retainer 148 to assist in retaining the inner lock 140 in the main cavity 112 of the outer cap 110. The retainer 148 may have any suitable form, configuration and operation. In this embodiment, the retainer 148 is a snap ring 150 engageable in an outer groove 141 formed around the outer circumference of the inner lock 140, and an inner groove 115 formed in the cavity wall 116 of the outer cap 110. For example, but without limitation, the snap ring 150 may be an elastomeric 0-ring seal. When the exemplary inner lock 140 is properly positioned in the main cavity 112, the snap ring 150 assists in preventing the inner lock 140 from slipping out of the main cavity 112.

Still referring to FIGS. 1(a)-(d), in use of this embodiment, the snap ring 150 is engaged in the outer groove 141 of the inner lock 140, and then the inner lock 140 is inserted into the main cavity 112 of the outer cap 110. As the inner lock 140 is inserted into the main cavity 112, the snap ring 150 may be compressed by the cavity wall 116. This compression or deformation of the snap ring 150 may occur if the diameter 120 of the main cavity 12 is smaller than outer diameter formed by the snap ring 150 (around the inner lock 140). For example, the snap ring 150 may compress or deform into the outer groove 141 until the inner lock 140 is fully inserted in the cavity 112. The shape of the snap ring 150 may assist in allowing insertion of the inner lock 140 and snap ring 150 into a smaller ID cavity 112. For example, the snap ring 150 or other retainer 148 may have a wedge-shape, or tapered cross-sectional shape, that allows passage into the cavity 112.

Once the illustrated inner lock 140 is fully inserted in the outer cap 110, the snap ring 150 will snap, or expand, into the inner groove 115 formed in the cavity wall 116 of the outer cap 110, preventing the snap ring 150 and inner lock 140 from slipping out of, or being easily removed from, the outer cap 110, but allowing the inner lock 140 and outer cap 110 to rotate relative to one another without substantial friction therebetween. The outer diameter formed by the exemplary snap ring 150 around the inner lock 140 should not be so large that friction between the snap ring 150 and the inner cavity wall 116 would prevent the outer cap 110 from rotating independent of the inner lock 140.

Still referring to FIG. 1(a)-(d), the exemplary snap ring 150 sits on a ledge 117 of the groove 115, assisting in retaining the inner lock 140 in the outer cap 110 and allowing relative movement therebetween. For example, the outer surface 152 of the snap ring 150 that engages the ledge 117 may be flat so that it firmly engages the ledge 117. For another example, the snap ring 150 may include shape-memory material, such as shape-memory alloy(s) or polymer(s), to assist in firmly engaging the outer groove 141 of the inner lock 140 and the inner groove 115 of the outer cap 110.

In other embodiments, referring to FIG. 8, the retainer, such as the snap ring 150, may not engage an inner groove 115 formed in the cavity wall 116 of the outer cap 110. For example, the outer cap 110 may have an upper section 122 of the wall 116 that forms an upper section 126 of the cavity 112 that has a diameter 128 greater than the diameter 120 (FIG. 1(c)) of a lower section 130 of the cavity 112 formed by a lower section 124 of the wall 116. In this embodiment, the retainer 148 sits on a ledge 132 formed between the upper and lower section 122, 124 of the wall 116.

However, a snap ring 150 is not required for all embodiments. Other suitable methods and components may be used for retaining the inner lock 140 within the outer cap 110 and, at the same time, allowing their relative rotation without significant friction. For example, the inner lock 140 may be retained within the cavity 112 with the use of one or more clips (not shown) that do not significantly impede the independent rotation of the inner lock 140 and outer cap 110. For another example, after the inner lock 140 is placed inside the cavity 112, the opening 118 of the outer cap 110 may be reshaped to retain the inner lock 140 inside the cavity 112 by any suitable technique, such as by crimping, bending, compressing or striking (e.g. swedging with a hammer), but without significantly impeding the independent rotation of the outer cap 110 and inner lock 140.

Referring now to FIGS. 2(a) and (b), the key 900 may have any suitable form, configuration and operation sufficient to concurrently rotate the inner lock 140 and outer cap 110 and disengaged the outer lock 140 from the gas source (not shown). Likewise, the key 900 may be constructed of any suitable material or combination of materials, such as stainless steel, aluminum or molded plastic, and may be manufactured by any suitable process, such as machining, casting, stamping or molding.

In this example, the key 900 includes a pair of pivotably connected arms 906, 908 having two engagement fingers 901, 902 extending therefrom, respectively. For example, the arms 906, 908 may be pivotable about a pivot pin 905. The exemplary engagement fingers 901, 902 are sized and shaped to fit within the respective aligned key insertion passage(s) 113 of the outer cap 110 and key receiver(s) 142 of the inner lock 140.

In this embodiment, the arms 906, 908 and respective finger 901, 902 are movable between at least one open position (e.g. FIG. 2(a)) and at least one closed position e.g. (FIG. 2(b)) by pivoting one or both arms 906, 908 about the pivot pin 905. In the open position, the exemplary fingers 901, 902 are not engaged with the outer cap 110 or inner lock 140. In the closed position, the illustrated fingers 901, 902 are engaged in the key insertion passage(s) 113 of the outer cap 110 and key receiver(s) 142 of the inner lock 140. When the exemplary fingers 901, 902 are in the closed position, the outer cap 110 and the inner lock 140 may be concurrently rotated to disengage the inner lock 140 from the gas source (not shown) by rotating the key 900 (or holding the fingers 901, 902 in the closed position and rotating the outer cap 140). Also, in the closed position of the engagement fingers 901, 902, the illustrated key 900 will allow the inner lock 140 to be torqued tightly against a gaseous access control port (e.g. Schrader valve) of the gas source (not shown) for secure engagement therewith without significant risk of damaging the cap lock system 100.

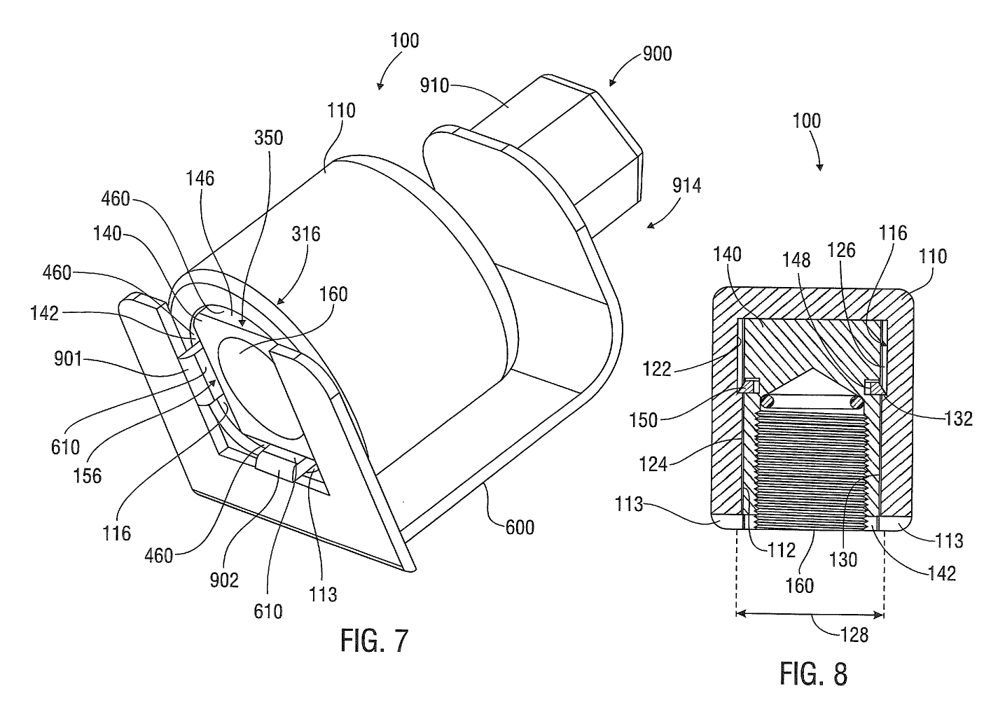

Referring back to FIG. 1(d), if desired, the key 900 may include one or more handles 910 that allow the key 900 to be rotated, such as by hand or with the use of a tool. The handle(s) 910 may have any suitable form, configuration and operation, and may be integral with key 900 or attached thereto in any suitable manner. In this embodiment, the handle includes a pair of metal studs 912, each welded to and extending upwardly from the upper end 912 of one of the arms 906, 908. When the arms 906, 908 are in the closed position, the handles 910 align adjacent to one another and can be gripped to rotate the key 900. If desired, the key 900 or handle(s) 910 may be shaped for easy rotation of the key 900. For example, the handles 910 could form a hexagonal shape (e.g. FIG. 7) to be engaged by a wrench.

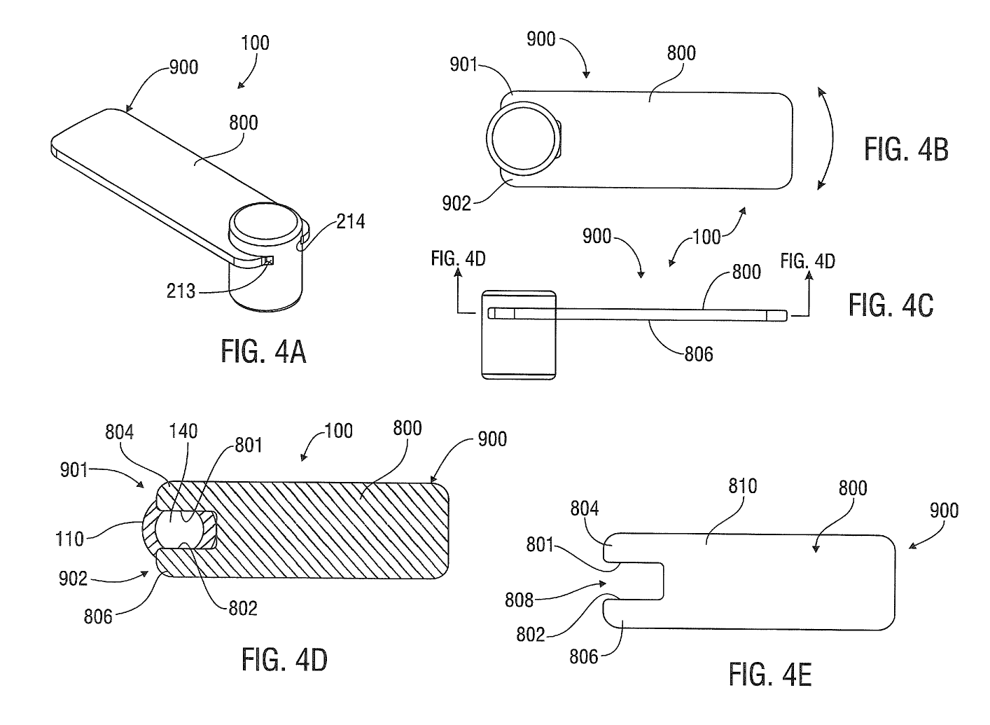

In the embodiment of FIGS. 3(a)-(c), the key insertion passages 113 of the outer cap 110 include at least two opposing channels 213, 214 extending into the main cavity 112. The key receivers 142 of the inner lock 140 of this embodiment are opposing channels 242, 243 alignable under the channels 213, 214, respectively, when the inner lock 140 is properly positioned in the cavity 112. As shown in FIGS. 4(a)-(d), the key 900 of this embodiment is a plate 800 and the engagement fingers 901, 902 are spaced-apart lips 804, 806. The exemplary lips 804, 806 slide laterally into engagement with the respective aligned channels 213, 242 (FIG. 3(a)) and channels 214, 243 of the properly aligned outer cap 110 and inner lock 140.

In use of this embodiment, the illustrated lip 804 has an edge 801 that engages the aligned channels 213, 242, and the lip 806 has an edge 802 that engages the aligned channels 214, 243. After engaging the edges 801, 802 with the outer cap 110 and inner lock 140, rotation of the plate 800 will rotate the outer cap 110 and inner lock 140, allowing the inner lock 140 to be disengaged from the gas source (not shown). The illustrated plate 800 will also allow the inner lock 140 to be torqued tightly against a gaseous access control port (e.g. Schrader valve) of the gas source (not shown) for secure engagement therewith without significant risk of damaging the cap lock system 100.

As shown in FIG. 4(e), if desired, the plate 800 may be formed by molding or die cutting an opening 808 in one end of a flat planar material 810 to create the lips 804, 806 and edges 801, 802 thereof. The material 801 and opening 808 may be sized and shaped so that the edges 801, 802 fit snugly in both in the respective aligned corresponding channels 213, 242 (FIG. 3(a)) and channels 214, 243.

In the embodiment of FIGS. 5(a)-(c), the key insertion passages 113 of the outer cap 110 include at least two opposing notches 313, 314 formed in the lower rim 316 of the outer cap 110 and extending into the main cavity 112. The exemplary key receivers 142 of the inner lock 140 include at least two opposing notches 342, 343 formed in the lower rim 350 thereof and alignable with the notches 313, 314, respectively.

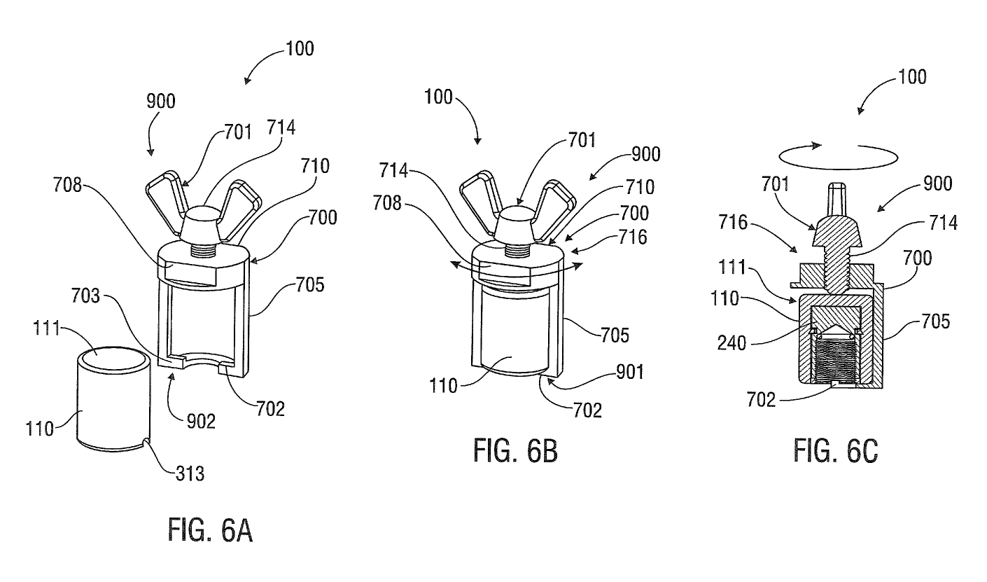

As shown in FIGS. 6(a)-(c), the illustrated key 900 is a gripper 700 and the engagement fingers 901, 902 are upwardly-facing opposing ridges 702, 703 extending off a main body 705 of the gripper 700. The exemplary ridges 702, 703 are sized and shaped to fit snugly within the aligned notches 313, 342 (FIG. 5(a) and aligned notches 314, 343, respectively. After the ridges 702, 703 are engaged with the notches 313, 342 and 314, 343, the body 705 is rotatable, rotating the outer cap 110 and inner lock 240 and allowing the inner lock 240 to be disengaged from the gas source (not shown). For example, the gripper 700 may have at least two engagement faces 708, 710 that may be gripped with a tool (e.g. wrench) or by hand for rotating the gripper 700. The illustrated gripper 700 will also allow the inner lock 140 to be torqued tightly against a gaseous access control port (e.g. Schrader valve) of the gas source (not shown) for secure engagement therewith without significant risk of damaging the cap lock system 100.

If desired, the gripper 700 may include a tightener 701 to ensure the ridges 702, 703 tightly engage and remain engaged with the respective aligned notches 313, 342 and 314, 343. In this embodiment, the tightener 701 is a screw 714 threaded through a hole in the top 716 of the main body 705 and tightenable against the outer cap 110. When the gripper 700 is placed over the outer cap 110 and the ridges 702, 703 are aligned with the corresponding notches 313, 342 and 314, 343, the screw 701 may be tightened down onto the upper end 111 of the outer cap 110, securing the ridges 702, 703 into a tight engagement with the corresponding notches 313, 342 and 314, 343.

In other embodiments, such as shown in FIG. 7, the lower end 156 of the inner lock 140 has a non-cylindrical outer shape, forming multiple gaps 460 at particular locations between its outer surface 146 and the cavity wall 116. In this example, the inner lock 140 has a square outer shape, forming two sets of opposing gaps 460. However, the inner lock 140 could have any other desired shape, as long as at least one gap 460 is formed. For example, only the bottom portion of the inner lock 140 may have a non-cylindrical shape. For another example, the lower rim 350 may be formed with cut-outs or indentations (not shown) forming the gaps 460.

In this embodiment, the illustrated key 900 is a gripper 600 and the engagement fingers 901, 902 include at least two upwardly-facing teeth 610 sized and shaped to fit (perhaps snugly) into one of the spaces 460. After the illustrated teeth 610 are engaged with the corresponding spaces 460, the gripper 600 may be rotated to concurrently rotate the inner lock 140 and the outer cap 110, allowing the cap lock system 100 to be disengaged from the gas source (not shown). The illustrated gripper 600 will also allow the inner lock 140 to be torqued tightly against a gaseous access control port (e.g. Schrader valve) of the gas source (not shown) for secure engagement therewith without significant risk of damaging the cap lock system 100. Other than as described above, the features and capabilities of the cap lock systems 100 shown in FIGS. 3(a)-8 are similar or identical to those described above with respect to FIGS. 1(a)-2(d).

Preferred embodiments of the present disclosure thus offer advantages over the prior art and are well adapted to carry out one or more of the objects of this disclosure. However, the present invention does not require each of the components and acts described above and is in no way limited to the above-described embodiments or methods of operation. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

1. A cap lock system for limiting access to an access port of a gaseous system, the cap lock system comprising:
an outer cap having upper and lower ends, a cavity and an opening to said cavity formed in said lower end thereof, said outer cap having a side wall extending between said upper and lower ends, said side wall having a lower rim forming said opening and extending around said cavity, said outer cap including at least first and second key insertion passages formed in opposing sides of at least one among said lower rim and said side wall and extending into said cavity;
an inner lock having upper and lower ends, a cavity and an opening to said cavity formed in said lower end thereof, said inner lock having a side wall extending between said upper and lower ends, said side wall having a lower rim forming said opening and extending around said cavity, said inner lock being configured to fit and independently rotate within said cavity of said outer cap and releasably engage the access port of the gaseous system,
said inner lock having at least first and second key receivers formed in opposing sides of at least one among said lower rim and said side wall thereof, said key receivers being configured to align with and under said respective key insertion passages of said outer cap when said inner lock in disposed within said cavity of said outer cap, wherein when said inner lock is disposed within said outer cap, said inner lock is inaccessible other than through said aligned key insertion passages and key receivers; and
a rotatable key having at least first and second engagement fingers configured to be engaged with said respective aligned key insertion passages of said outer cap and key receivers of said inner lock, wherein when said inner lock is engaged with the gaseous system and disposed within said cavity of said outer cap and said engagement arms engage said respective aligned key insertion passages and key receivers, said key is configured to be rotated to cause concurrent rotation of said outer cap and said inner lock relative to the gaseous system, disconnecting said inner lock from the access port of the gaseous system.

2. The cap lock system of claim 1 further including at least one wedge-shaped retainer engaged around said inner lock and engageable with an inner surface of said outer cap around said cavity therein.

3. The cap lock system of claim 2 further including a first groove formed in the outer surface of said inner lock and a second groove formed in said inner surface of said outer cap, wherein said wedge-shaped retainer engages said first and second grooves.

4. The cap lock system of claim 2 wherein said cavity of said outer cap has an upper section and a lower section, said upper section having a diameter that is greater than the diameter of said lower section and forming a ledge therebetween, wherein said wedge-shaped retainer engages said ledge.

5. The cap lock system of claim 1 further including at least one snap-ring engaged around said inner lock and having a flat outer surface, said flat outer surface configured to engage a ledge of said outer cap extending around said cavity therein.

6. The cap lock system of claim 5 wherein said cavity of said outer cap has an upper section and a lower section, said upper section having a diameter that is greater than the diameter of said lower section and forming said ledge therebetween.

7. The cap lock assembly of claim 1 wherein said key insertion passages of said outer cap are holes formed in opposing sides of said sidewall thereof and said key receivers of said inner lock are indents formed in opposing sides of said sidewall thereof.

8. The cap lock assembly of claim 7 wherein said key includes a pair of pivotably connected arms, each said arm having one of said first and second engagement fingers.

9. The cap lock assembly of claim 1 wherein said key insertion passages of said outer cap are channels formed in opposing sides of said sidewall thereof and said key receivers of said inner lock are channels formed in opposing sides of said sidewall thereof.

10. The cap lock assembly of claim 8 wherein said key is a plate and said engagement fingers are spaced-apart lips on said plate.

11. The cap lock assembly of claim 1 wherein said key insertion passages are notches formed in said lower rim thereof and said key receivers of said inner lock are notches formed in said lower rim thereof.

12. The cap lock assembly of claim 11 wherein said key is a gripper and said engagement fingers are upwardly facing ridges on said gripper.

13. The cap lock system of claim 1 wherein said key includes a tightener configured to ensure said first and second engagement fingers firmly engage said respective aligned key insertion passages of said outer cap and key receivers of said inner lock.

14. The cap lock system of claim 13 wherein said tightener includes a screw configured to engage said upper end of said outer cap.

15. The cap lock system of claim 1 wherein said lower end of said inner lock has a non-cylindrical outer shape forming at least two distinct gaps with said side wall of said outer cap forming said cavity, wherein said engagement fingers of said key are upwardly facing teeth engageable in said gaps, respectively.

16. The cap lock system of claim 15 wherein said lower end of said inner lock includes at least two indentations forming the at least two distinct gaps.
